(19) United States
(12) Patent Application Publication
(10) Pub. No.: US 2022/0372818 A1
(43) Pub. Date: Nov. 24, 2022

(54) DRIVE THROUGH GATE DEVICE

(71) Applicant: Casey Johnson, Stanley, ND (US)

(72) Inventor: Casey Johnson, Stanley, ND (US)

(21) Appl. No.: 17/747,012

(22) Filed: May 18, 2022

Related U.S. Application Data
(60) Provisional application No. 63/189,864, filed on May 18, 2021.

(51) Int. Cl. E06B 11/02; E06B 11/04

(52) U.S. Cl. CPC E06B 11/027; E06B 11/04

(57) ABSTRACT

The present invention relates generally to the field of gates. More specifically, the present invention relates to a drive through gate device primarily comprised of at least one support post, at least one gate assembly, and at least one spring. The gate assembly is preferably attached on each end to a support post, wherein each support post is supported by a ground frame member. The gate assembly can then be driven over and through by a user in a vehicle such that the gate assembly rests on the ground surface in front of the device. After a vehicle has finished driving over and through the gate assembly, the gate assembly is returned to the vertical position parallel with the support posts via the spring.

### CROSS-REFERENCE TO RELATED APPLICATION

The present application claims priority to, and the benefit of, U.S. Provisional Application No. 63/189,864, which was filed on May 18, 2021, and is incorporated herein by reference in its entirety.

### FIELD OF THE INVENTION

The present invention relates generally to the field of gates. More specifically, the present invention relates to a drive through gate device primarily comprised of at least one support post, at least one gate assembly, and at least one spring. The gate assembly is preferably attached on each end to a support post, wherein each support post is supported by a ground frame member. The gate assembly can then be driven over and through by a user in a vehicle such that the gate assembly rests on the ground surface in front of the device. After a vehicle has finished driving over and through the gate assembly, the gate assembly is returned to the vertical position parallel with the support posts via the spring. Accordingly, the present disclosure makes specific reference thereto. Nonetheless, it is to be appreciated that aspects of the present invention are also equally applicable to other like applications, devices and methods of manufacture.

### BACKGROUND

Many farmers and ranchers have numerous fences throughout their farm or property. Farmers and ranchers may also frequently enter and exit fenced areas on their farm or property throughout the day. These fenced areas often contain a gate which must be opened and closed in order to enter and exit the fenced area. This process requires that an individual exit their vehicle to open the gate, return back to their vehicle to drive through the open gate, exit their vehicle again once they have driven through the gate to close the gate behind them, and then re-enter their vehicle. This process is time-consuming and unnecessary. Further, if a gate is not closed quick enough then livestock within the fenced area may escape said area, which is undesirable.

Therefore, there exists a long-felt need in the art for an improved fence gate. There also exists a long-felt need in the art for a drive through gate device that allows a user to exit or enter a fenced area without having to exit their vehicle. Further, there exists a long-felt need in the art for a drive through gate that allows a user to exit or enter a fenced area without having to exit their vehicle, wherein the gate quickly closes and opens. In addition, there exists a long-felt need in the art for a drive through fence gate device that automatically operates.

The subject matter disclosed and claimed herein, in one embodiment thereof, comprises a drive through gate device. The device is primarily comprised of at least one support post, at least one gate assembly, and at least one spring. In the preferred embodiment, the gate assembly is attached on each end to a support post, wherein each support post is supported by a ground frame member. The gate assembly can then be driven over and through by a user in a vehicle such that the gate assembly rests on the ground surface in front of the device. After a vehicle has finished driving over the gate assembly, the gate assembly is returned to the vertical position parallel with the support posts via the spring.

In this manner, the drive through gate device of the present invention accomplishes all of the foregoing objectives and provides an improved fence gate. The device allows a user to exit or enter a fenced area without having to exit their vehicle. Further, the device allows a user to exit or enter a fenced area without having to exit their vehicle, wherein the gate quickly closes and opens and automatically operates.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a drive through gate device. The device is primarily comprised of at least one support post, at least one gate assembly, and at least one spring. The device preferably has two main support posts, wherein each post is positioned on one side of the gate assembly. The bottom of each post attaches to at least one ground frame member.

The gate assembly is comprised of at least one main support frame and at least one vertical prong. The main support frame is comprised of at least one vertical frame member and at least one horizontal frame member. A horizontal frame member may also have at least one wheel plate that covers the horizontal frame member and allows a vehicle to smoothly drive over the horizontal member without significant disturbance to the vehicle and vehicle occupants. The gate assembly also comprises at least one vertical prong that attaches to the main support frame, and preferably to the at least one horizontal frame member.

The horizontal frame member of the gate assembly further attaches on each side to each ground frame member such that the entire gate assembly can swing upwards and downwards within a 180-degree range of movement relative to the ground surface the device rests on. A portion of the main support frame and the top (or any other portion thereof) of the main support post are further comprised of at least one eyelet wherein at least one spring removably or fixedly attaches to each eyelet.

To use the device, a user drives their vehicle into the gate assembly such that the wheels of the vehicle contact the main support frame. Therefore, as the vehicle travels forward the vehicle wheels ride over the wheel plates and the main support frame is pushed forward and thereby rotated downwards toward the ground surface until the gate assembly rests on the ground surface. At this point, the vehicle can then drive over and through the gate assembly. After the vehicle completes driving over and through the gate assembly, the springs automatically return the gate assembly to a vertical position parallel to the main support posts.

Accordingly, the drive through gate device of the present invention is particularly advantageous as it provides an improved fence gate that allows a user to exit or enter a fenced area without having to exit their vehicle. In addition, the gate quickly closes and opens and also automatically operates without the need for user input. In this manner, the drive through gate device overcomes the limitations of existing fence gates known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a drive through gate device of the present invention in accordance with the disclosed architecture; and

FIG. 2 illustrates a perspective view of one potential embodiment of a drive through gate device of the present invention while being used by a vehicle in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved fence gate. There also exists a long-felt need in the art for a drive through gate device that allows a user to exit or enter a fenced area without having to exit their vehicle. Further, there exists a long-felt need in the art for a drive through gate that allows a user to exit or enter a fenced area without having to exit their vehicle, wherein the gate quickly closes and opens. In addition, there exists a long-felt need in the art for a drive through fence gate device that automatically operates.

The present invention, in one exemplary embodiment, is comprised of a drive through gate device primarily comprised of at least one support post, at least one gate assembly, and at least one spring. The device is preferably comprised of two main support posts, wherein each post is positioned on one side of the gate assembly. Further, the bottom of each post attaches to at least one ground frame member.

The gate assembly is comprised of at least one main support frame and at least one vertical prong. The main support frame is comprised of at least one vertical frame member and at least one horizontal frame member. A horizontal frame member may also be comprised of at least one wheel plate. The wheel plate covers the horizontal frame member and allows a vehicle to smoothly drive over the horizontal member without significant disturbance to the vehicle and vehicle occupants. The gate assembly is also comprised of at least one vertical prong that attaches to the main support frame, and preferably to the at least one horizontal frame member of the main support frame.

The horizontal frame member of the gate assembly further attaches on each end to each ground frame member. This allows the entire gate assembly to swing upwards and downwards within a 180-degree range of movement relative to the ground surface the device rests on. The main support frame and the top (or any other portion thereof) of the main support post are further comprised of at least one eyelet wherein at least one spring removably or fixedly attaches to each eyelet.

During use, a user drives their vehicle into the gate assembly such that the wheels of the vehicle contact and push the main support frame forward. Therefore, as the vehicle travels forward the vehicle wheels ride over the wheel plates and the main support frame is pushed and rotated downwards toward the ground surface until the gate assembly rests on the ground surface. At this point, the vehicle can then drive over and through the gate assembly. After the vehicle completes driving through the gate assembly, the springs automatically return the gate assembly to a vertical position parallel to the main support posts.

Accordingly, the drive through gate device of the present invention is particularly advantageous as it provides an improved fence gate that allows a user to exit or enter a fenced area without having to exit their vehicle. In addition, the gate quickly closes and opens, and also automatically operates without the need for user input. In this manner, the drive through gate device overcomes the limitations of existing fence gates known in the art.

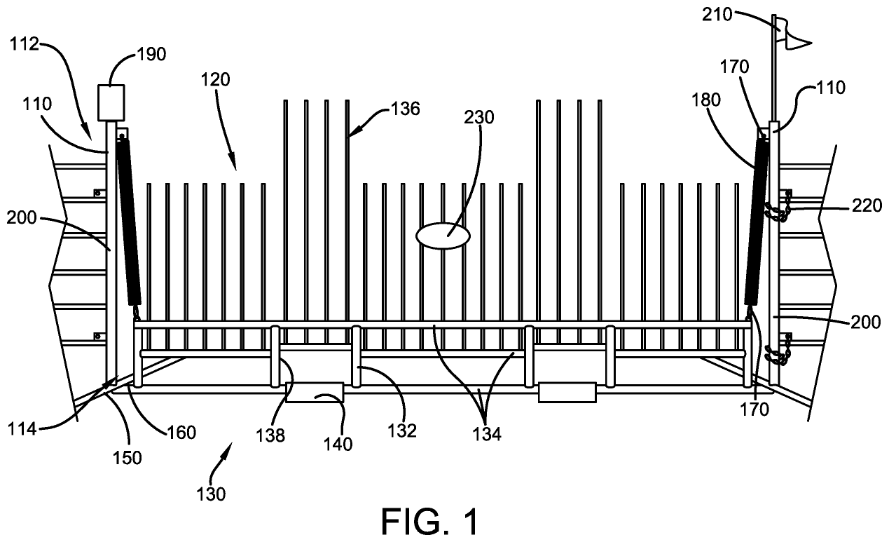

Referring initially to the drawings, FIG. 1 illustrates a front perspective view of one potential embodiment of a drive through gate device 100 of the present invention in accordance with the disclosed architecture. The device 100 is primarily comprised of at least one support post 110, at least one gate assembly 120, and at least one spring 180. Unless otherwise stated herein, all components of the device 100 are preferably manufactured from a durable metal such as, but not limited to: stainless steel or aluminum. It is appreciated that the durable metal is corrosion resistant in the preferred embodiment, to allow the device 100 to withstand prolonged outdoor weather exposure.

The device 100 is preferably comprised of two main support posts 110, wherein each post 110 is positioned on one side of the gate assembly 120. The bottom 114 of each post 110 attaches to at least one ground frame member 150. The ground frame member 150 may further be weighted such that the main support post 110 remains secured in a vertical position at 90 degrees relative to the ground frame member 150 while the gate assembly 120 moves.

The gate assembly 120 is comprised of at least one main support frame 130 and at least one vertical prong 136. It should be appreciated that all components of the gate assembly 120 may be fixedly or removably attached to one another. In a removable embodiment, the components of the gate assembly 120 are threadedly attached or bolted to one another. The main support frame 130 provides structural rigidity and support to the gate assembly 120. The main support frame 130 is comprised of at least one vertical frame member 132 and at least one horizontal frame member 134. The frame members 132,134 may be arranged to form at least one opening 138 that allows a piece of machinery, such as a forklift, tractor with forks, etc., to pick up and move the device 100 as needed from, and to, various locations. A horizontal frame member 134 may also be comprised of at least one wheel plate 140 that covers the horizontal frame member 134 and allows a vehicle 10 to smoothly drive over the horizontal member 134 without significant disturbance to the vehicle 10 and vehicle occupants. The opening 138 may also allow for clearance of the wheel plate 140 as the gate assembly 120 rotates. The gate assembly 120 is also comprised of at least one vertical prong 136 that attaches to the main support frame 130, and preferably to the at least one horizontal frame member 134. Any portion of the gate assembly 120 may also include at least one logo 230 or symbol that may represent the name of a ranch, property, owner, etc. of where the device 100 is being used.

The horizontal frame member 134 of the gate assembly 120 further attaches on each side to each ground frame member 150 via at least one opening 160 in each ground frame member 150. The attachment allows the horizontal frame member 134, and thus the entire gate assembly 120, to swing upwards and downwards within a 180-degree range of movement relative to the ground surface the device 100 rests on. The main support frame 130 and the top 112 (or any other portion thereof) of the main support post 110 are further comprised of at least one eyelet 170. At least one spring 180 removably or fixedly attaches to each eyelet 170.

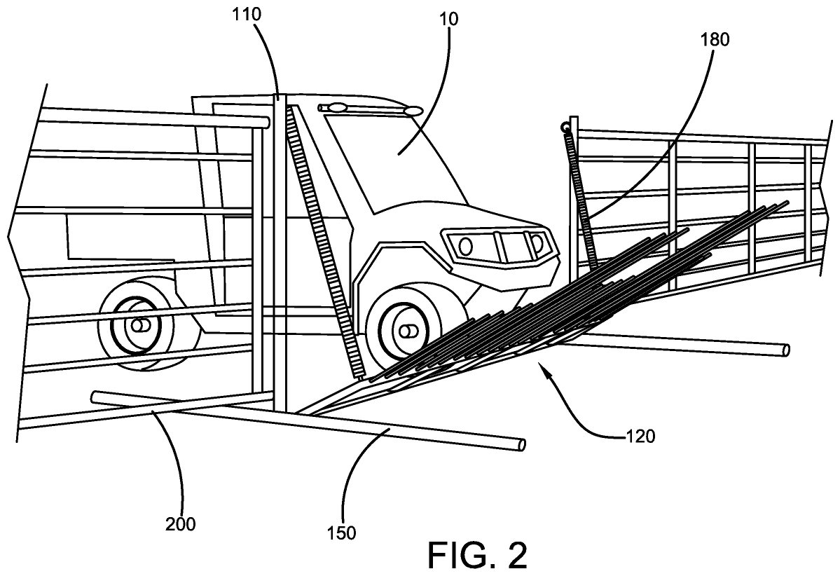

FIG. 2 illustrates a perspective view of one potential embodiment of a drive through gate device 100 of the present invention while being used by a vehicle 10 in accordance with the disclosed architecture. To use the device 100, a user drives a vehicle 10 into the gate assembly 120 such that the wheels of the vehicle 10 contact the main support frame 130 and push the frame 130 forwards (i.e., in the direction the vehicle 10 is traveling). As the vehicle 10 travels forward, the vehicle wheels ride over the wheel plates 140 and the main support frame 130 (and therefore the entire gate assembly 120) is pushed and rotated downwards toward the ground surface until the entire gate assembly 120 rests on the ground surface (while the support posts 110 remain vertical). At this point, the vehicle 10 can then drive over and through the gate assembly 120. In differing embodiments, the vertical prongs 136 may be of different lengths to ensure differing types and sizes of vehicles 10 can drive over the gate assembly 120 while ensuring the assembly 120 adequately contacts the wheels of the vehicle 10 and the gate 120 does not raise or lower prematurely. After the vehicle 10 completes driving over and through the gate assembly 120, the springs 180 automatically return the gate assembly 120 to a vertical position parallel to the main support posts 110.

In one embodiment, the device 100 may be comprised of at least one solar powered light 190 and at least one windsock 210. The device 100 and all components may also be reflective to ensure the device 100 can be easily spotted at night. Further, the device 100 may be comprised of at least one wire or metal-barred panel 200. The panel 200 may further be attached to at least one main support post 110. In this manner, a plurality of panels 200 can be used to create a temporary corral or pen, using the gate assembly 120 as the entrance and exit to said corral or pen.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “drive through gate device” and “device” are interchangeable and refer to the drive through gate device 100 of the present invention.

Notwithstanding the forgoing, the drive through gate device 100 of the present invention and its various components can be of any suitable size and configuration as is known in the art without affecting the overall concept of the invention, provided that they accomplish the above-stated objectives. One of ordinary skill in the art will appreciate that the size, configuration and material of the drive through gate device 100 as shown in the FIGS. are for illustrative purposes only, and that many other sizes and shapes of the drive through gate device 100 are well within the scope of the present disclosure. Although the dimensions of the drive through gate device 100 are important design parameters for user convenience, the drive through gate device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A drive through gate device comprising:
a main support post;
a gate assembly comprised of a main support frame and a vertical prong;
a ground frame member;
an eyelet; and
a spring.

2. The drive through gate device of claim 1, wherein the gate assembly is repositionable in both an upward direction and a downward direction within a 180-degree range of movement relative to a ground surface.

3. The drive through gate device of claim 1, wherein the spring is attached to each of the main support post and to the gate assembly.

4. The drive through gate device of claim 1, wherein the ground frame member further comprises an extra weight.

5. A drive through gate device comprising:
a main support post having a first eyelet;
a ground frame member attached to the main support post;
a gate assembly comprised of a main support frame having a second eyelet, a wheel plate, a vertical prong, a horizontal frame member and a vertical frame member; and
a spring.

6. The drive through gate device of claim 5, wherein the gate assembly is repositionable in both an upward direction and a downward direction within a 180-degree range of movement relative to a ground surface.

7. The drive through gate device of claim 5, wherein the horizontal frame member and the vertical frame member form an opening.

8. The drive through gate device of claim 5, wherein the ground frame member attaches to the main support post at 90 degrees relative to the main support post.

9. The drive through gate device of claim 5, wherein the spring connects to the eyelet of the main support post and to the eyelet of the main support frame.

10. The drive through gate device of claim 9, wherein the eyelet is located on the horizontal frame member of the main support frame.

11. A drive through gate device comprising:
a main support post having a first eyelet;
a ground frame member attached to the main support post;
a gate assembly comprised of a main support frame having a horizontal frame member, a vertical frame member and a second eyelet, a wheel plate and a vertical prong;
a spring;
a windsock;
a solar powered light; and
a panel.

12. The drive through gate device of claim 11, wherein the panel is attached to the main support post via a hook and chain assembly.

13. The drive through gate device of claim 11 further comprising a reflective material.

14. The drive through gate device of claim 12, wherein the panel is a wire panel or a metal-barred panel.

15. The drive through gate device of claim 11, wherein the spring attaches to the first eyelet and the second eyelet.

16. The drive through gate device of claim 11, wherein the gate assembly is repositionable in both an upward direction and a downward direction within a 180-degree range of movement relative to a ground surface.

17. The drive through gate device of claim 16, wherein a swinging of the drive through gate device is assisted by the spring.

18. The drive through gate device of claim 11, wherein the vertical prong is comprised of a logo.

19. The drive through gate device of claim 11, wherein the main support frame has an opening around the wheel plate.

20. The drive through gate device of claim 11, wherein the ground frame member comprises an extra weight.
